(19) United States
(12) Patent Application Publication
(10) Pub. No.: US 2006/0128213 A1
(43) Pub. Date: Jun. 15, 2006

(54) Connector and nut holding structure for connector

(75) Inventors: Takuya Higeta, Tokyo (JP); Kazuyuki Ozai, Tokyo (JP)

Correspondence Address: ABELMAN, FRAYNE & SCHWAB, 666 THIRD AVENUE, 10TH FLOOR, NEW YORK, NY, 10017, US

(73) Assignee: DDK LTD.

(21) Appl. No.: 11/282,007

(22) Filed: Nov. 15, 2005

(30) Foreign Application Priority Data
Dec. 14, 2004 (JP) 2004-360951

(51) Int. Cl. H01R 13/73

(52) U.S. Cl. 439/564

(57) ABSTRACT

A connector includes a plurality of contacts, an insulator for arranging and holding the contacts, and a nut for securing the connector to a substrate or panel. The insulator is provided at a predetermined position with a flange which is formed with an inserting portion for accommodating the nut, and at the inserting portion at least two elastic pieces are arranged which are elastically deformable and adapted to engage the nut. The nut holding structure thus constructed for the connector is able to securely hold the nut with the simple construction without any fracture of the insulator.

### BACKGROUND OF THE INVENTION

The present invention relates to a connector for use in various kinds of electronic and electric appliances, and more particularly to a nut holding structure for mounting a connector onto a substrate or the like.

In general, connectors are used to connect between electronic and electric appliances for exchanging signals between these appliances. Therefore, the connectors are each mounted on a substrate or panel for connecting the connector to a mating connector. For this purpose, the connector is secured to a substrate, panel or the like by means of metal fixtures, screws and nuts or the like.

In usual, the screws and nuts are supplied from manufactures to customers together with connectors as their accessories or are prepared by the customers themselves. In recent years, there have been customer's requirements for nuts originally fixed to a connector, arising from problems of man-hours of management or in order to avoid loss of nuts.

Following Patent Literatures 1 to 3 have disclosed examples of nuts supplied as accessories from a manufacturer, nuts originally fixed to a connector by press-fitting and nuts embraced by a separate part and an insulator as a housing.

Patent Literature 1

According to Abstract of Japanese Utility Model Application Opened No. H5-25,680/1993, this utility model has an object to improve the operationality of fastening for clamping a printed circuit board connector to a printed circuit board and a mating connector by means of screws and to ensure earthing or grounding of metal shield applied to a printed circuit board connector. The printed circuit board connector is formed with substrate mounting flanges and connecting holding flanges, where the fixation to a substrate and the connecting holding with a mating connector are carried out by means of screw fastening at the respective flanges. The respective flanges are each formed with recesses for nuts, and the connection portion to be connected to a mating connector is shielded therearound by a metal shield. Nut fasteners each include two grasping portions integrally formed therewith for grasping the respective flange in a manner covering openings of the recesses for nuts. The grasping portions grasping the connecting holding flanges are directly in contact with the metal shield.

Patent Literature 2

According to Abstract of Japanese Patent Application Opened No. H5-242,928/1993, this invention has an object to provide a connector on the side of a substrate, which is able to combine a housing and a shield case to fix them to the substrate in an easy and simple manner and to earth or ground the shield case and the substrate with ease. The disclosed connector on the side of a substrate, which is fixed to the mounting substrate to be connected to a connector on the cable side, comprises a housing and a shield case. The housing is provided at both its ends with ground plates each for connecting the shield case and an earthing terminal of the mounting substrate.

Patent Literature 3

According to Abstract of Japanese Utility Model Application Opened No. H5-69,883/1993, this utility model has an object to provide a connector economically manufactured without requiring any different main bodies even if a method for mounting a connector onto a circuit board is altered according to the specification of a user. When the connector is mounted on a circuit board by means of bolts and nuts, the nuts are fitted in recesses of a connector main body, and the bolts are extended through through-holes of the circuit board and then screw-threadedly fitted in the nuts. When using plate-shaped locking members, fixed portions are fitted in through-holes, and locking portions consisting of branching pieces extend from the bottom surface of the connector main body 1 through a pair of grooves of the through-holes and are anchored to aperture margins of the circuit board, whereupon the locking portions are soldered thereto. When using a plate-shaped hold-down member, a pair of blade pieces at its one end are fitted in a pair of through-holes and a circuit board fixing portion at the other end is conducted outwardly of the bottom surface of the connector main body.

In the case using screws and nuts, commercially available products are frequently used without using special order ones, because the former is inexpensive. On proceeding of the miniaturization of connectors, screws of M1.6 to M4 (Japanese Industrial Standard) are commonly used to a great extent. Tolerances of the screws of M1.6 to M4 are approximately ±0.1 mm and their interference for press-fitting has to be designed in consideration of only nominal values of tolerance. In the case that nuts are fixed to a connector by press-fitting, therefore, if the nuts are undersized, they will be poorly press-fitted due to comparatively small interference so that they may be dislodged from the connector in shipping. On the other hand, if the nuts are oversized, an insulator may be likely to be damaged (whitening or blanching and cracking) owing to comparatively large interference.

In the case that nuts are supplied as accessories, man-hours of management for them may be increased. In the case that separate parts are prepared to embrace the nuts (except for a case commonly utilizing parts required for other purpose), moreover, man-hours of management may also be increased to lead increased cost.

### SUMMARY OF THE INVENTION

It is an object of the invention to provide a nut holding structure for a connector which overcomes the disadvantages of the prior art described above and which is able to securely hold nuts with a simple construction without any fracture of an insulator.

The above object can be achieved by the connector 10 including a plurality of contacts 14, an insulator 12 for arranging and holding the contacts 14, and a nut 16 for securing the connector 10 to a substrate or panel, wherein according to the invention the insulator 12 is provided at a predetermined position with a flange 18 which is formed with an inserting portion 20 for accommodating the nut 16, and at the inserting portion 20 at least two elastic pieces 22 are arranged which are elastically deformable and adapted to engage the nut 16.

Moreover, the object of a nut holding structure can be achieved by the nut holding structure for a connector 10 including a plurality of contacts 14, an insulator 12 for arranging and holding the contacts 14, and a nut 16 for securing the connector 10 to a substrate or panel, wherein according to the invention the insulator 12 is provided at a predetermined position with a flange 18 which is formed with an inserting portion 20 for accommodating the nut 16, and at the inserting portion 20 at least two elastic pieces 22 are arranged which are elastically deformable and adapted to engage the nut 16, thereby holding the nut 16 with the engagement with the elastic pieces 22.

In a preferred embodiment of the invention, the elastic pieces 22 are substantially in the form of an L-shape and are formed as a cantilever to make them likely to be elastically deformed. Preferably, notches 26 or recesses are provided around each of the elastic pieces 22. Moreover, the elastic pieces 22 are each provided at a tip with guiding means 24. The elastic pieces 22 are formed integrally with or separately from the insulator 12.

As can be seen from the above description, the connector and the nut holding structure for the connector can bring about the following significant effects.

(1) In a connector 10 including a plurality of contacts 14, an insulator 12, for arranging and holding the contacts 14, and a nut 16 for securing the connector 10 to a substrate or panel, according to the invention the insulator 12 is provided at a predetermined position with a flange 18 which is formed with an inserting portion 20 for accommodating the nut 16, and at the inserting portion 20 at least two elastic pieces 22 are arranged which are elastically deformable and adapted to engage the nut 16. Therefore, even if tolerances of nuts 16 are large, they can be securely held without any fracture of the insulator 12.

(2) In a nut holding structure for a connector 10 including a plurality of contacts 14, an insulator 12 for arranging and holding the contacts 14, and a nut 16 for securing the connector 10 to a substrate or panel, according to the invention the insulator 12 is provided at a predetermined position with a flange 18 which is formed with an inserting portion 20 for accommodating the nut 16, and at the inserting portion 20 at least two elastic pieces 22 are arranged which are elastically deformable and adapted to engage the nut 16, thereby holding the nut 16 with the engagement with the elastic pieces 22. Accordingly, even if tolerances of nuts 16 are large, they can be securely held without any fracture of the insulator 12.

(3) The elastic pieces 22 are substantially in the form of an L-shape and are formed as a cantilever to make them likely to be elastically deformed. Therefore, the elastic pieces 22 are elastically deformed with great certainty so that the nuts 16 can easily be inserted and securely held thereat.

(4) Notches 26 or recesses are provided around each of the elastic pieces 22. Accordingly, the elastic pieces are deformed with certainty.

(5) The elastic pieces 22 are each provided at a tip with guiding means 24. Consequently, the nut 16 can be reliably inserted into the inserting portion.

(6) The elastic pieces 22 are formed integrally with or separately from the insulator 12. Accordingly, the nut holding structure according to the invention can correspond to any cases of customer's requirements.

The invention will be more fully understood by referring to the following detailed specification and claims taken in connection with the appended drawings.

### BRIEF DESCRIPTION OF THE DRAWINGS

FIG. 1A is a perspective view of the connector according to the invention viewed from the above on the substrate connecting side;

FIG. 1B is a perspective view of the connector viewed from the fitting opening side;

FIG. 2A is a perspective view of the connector without nuts inserted, viewed from the above on the substrate connecting side;

FIG. 2B is a perspective view of the connector without nuts inserted, viewed from the fitting opening side;

FIG. 3A is a partly enlarged perspective view of the flange portion of the connector without a nut inserted;

FIG. 3B is a partly enlarged perspective view of the flange portion of the connector with the nut inserted;

FIG. 4A is a cross-sectional view of the flange portion of the connector without a nut inserted; and

FIG. 4B is a longitudinal-sectional view of the flange portion of the connector without a nut inserted.

### DESCRIPTION OF THE PREFERRED EMBODIMENTS

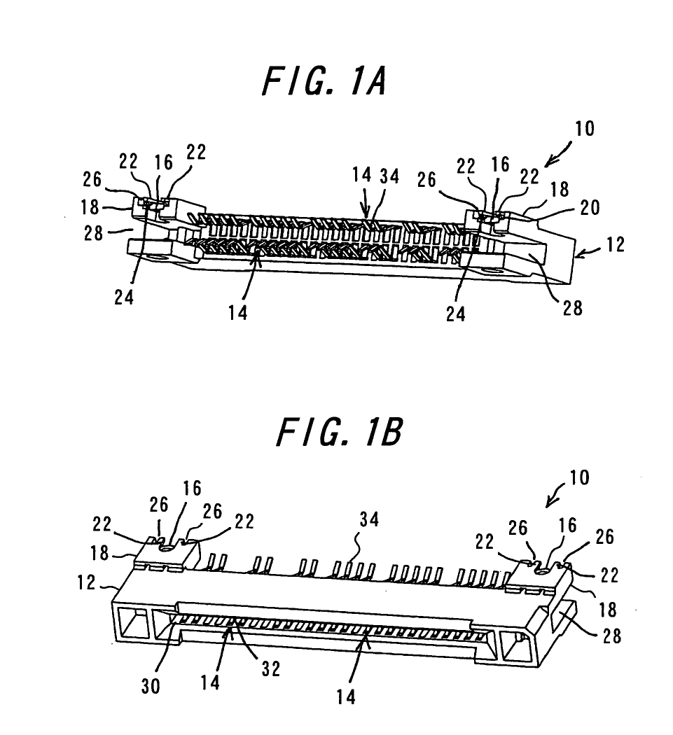

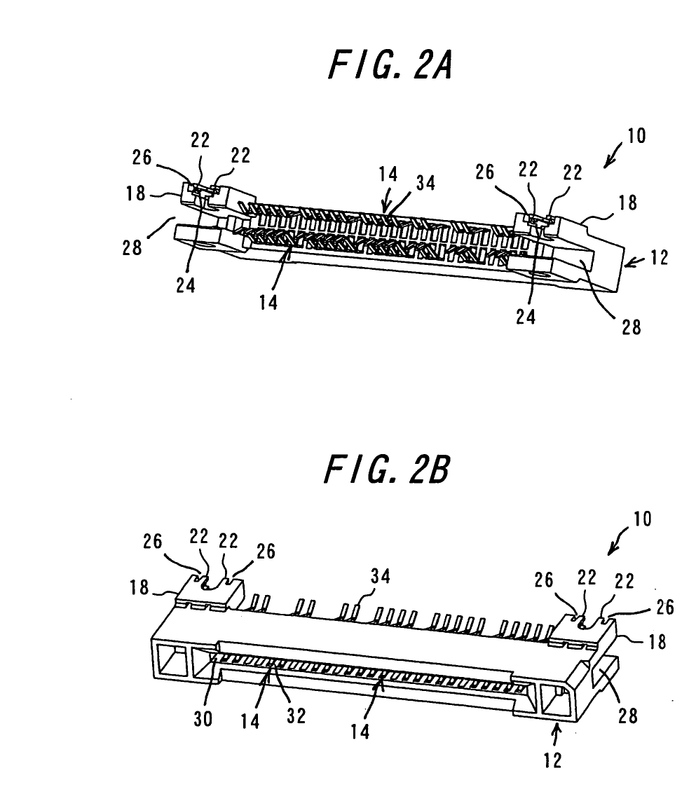

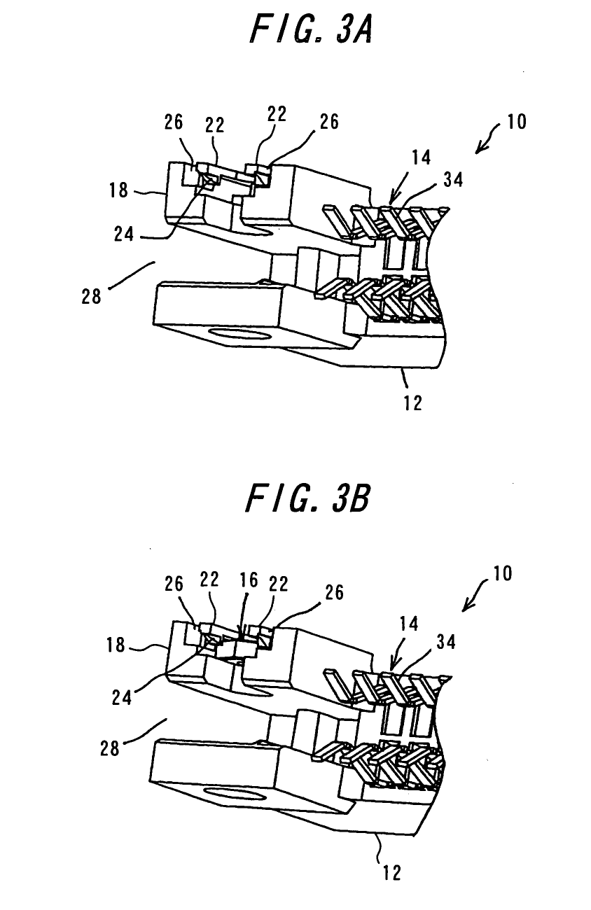

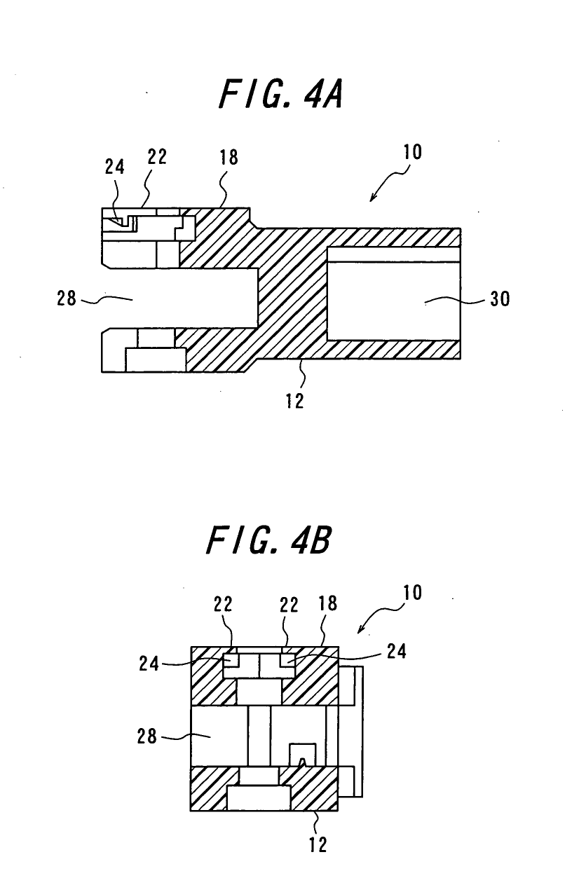

One embodiment of the connector 10 according to the invention will be explained with reference to FIGS. 1A to 4B. FIG. 1A is a perspective view of the connector according to the invention viewed from the above on the substrate connecting side, and FIG. 1B is a perspective view of the connector viewed from the fitting opening side. FIG. 2A is a perspective view of the connector without nuts inserted, viewed from the above on the substrate connecting side, while FIG. 2B is a perspective view of the connector without nuts inserted, viewed from the fitting opening side. FIG. 3A is a partly enlarged perspective view of the flange portion of the connector without the nut inserted, while FIG. 3B is a partly enlarged perspective view of the flange portion with the nut inserted. FIG. 4A is a cross-sectional view of the flange portion of an insulator without the nut inserted, and FIG. 4B is a longitudinal-sectional view of the flange portion without the nut inserted.

The connector 10 according to the one embodiment of the invention mainly comprises an insulator 12, contacts 14 and nuts 16.

First, the insulator 12 will be explained, which is a subject matter of the invention. The insulator 12 is formed from an electrically insulating plastic material by means of the injection molding of the known technique. The materials suitable for the insulator 12 include polybutylene terephthalate (PBT), polyamide (66PA, 46PA, or 9TPA), liquid crystal polymer (LCP), polycarbonate (PC) and the like and combination thereof in consideration of dimensional stability, workability, manufacturing cost and the like. The insulator 12 is provided with a fitting opening 30 adapted to be fitted with a mating connector. The size of the fitting opening 30 may be suitably designed so as to be fitted with the mating connector.

The insulator 12 is provided with flanges 18 at predetermined positions. The flanges 18 are adapted to be fixed to a substrate, a mating connector, a panel or the like and are each provided with an inserting portion 20 into which the nut 16 is inserted. Positions and sizes of the flanges 18 may be suitably designed according to a kind of a member to be connected to the connector and a customer's specification. In the illustrated embodiment, two flanges 18 are provided at longitudinal ends of the insulator for embracing and mounting a substrate therein. However, there may be provided a flange at the center of the insulator on the fitting side or the opposite side thereto depending upon the holding force for the substrate. The size of the inserting portions 20 may be designed to accommodate the nut 16 in consideration of the size and tolerance of commercially available nuts. The inserting portions 20 are approximately 0.05 mm to 0.4 mm larger than the nuts 16 in the illustrated embodiment.

At each of the inserting portions 20, at least two elastic pieces 22 are arranged which are elastically deformable and adapted to engage the nut 16. The size and shape of the elastic pieces 22 may be any ones insofar as they are able to engage the nut 16 and may be suitably designed in consideration of the elastic deformability, holding power for the nut, strength of the insulator 12 and the like. In the illustrated embodiment, the elastic pieces 22 are substantially in the form of an L-shape to facilitate the engagement with the nut, and the two elastic pieces are provided as shown in FIGS. 1A and 1B. In more detail, the elastic pieces 22 extend with their tips in consideration of the size and tolerance of the nut 16 to ensure the engagement with the nut 16. The tips of the elastic pieces extend 0.05 mm to 0.4 mm in the illustrated embodiment.

In order to enhance the elastic deformation of the elastic pieces 22 by forming them in a cantilevered manner, notches 26 or recessed are formed around the elastic pieces 22. The notches 26 or recesses may be any ones insofar as the elastic piece 22 forms a cantilever facilitating its elastic deformation, and may be suitably designed in consideration of the strength of the insulator 12.

Moreover, the elastic pieces 22 are each provided at the tip with a guide portion 24 for facilitating inserting the nut 16 into the inserting portion 20. The guide portion 24 is provided at the extending tip of the L-shaped elastic piece 22 and may be in the form of an inclined face, a chamfered portion or an R-shaped portion.

The elastic pieces 22 may be formed integrally with or separately from the insulator 12 insofar as they can engage the nut 16 to achieve their functions. The elastic pieces 22 are integrally formed with the insulator 12 in terms of man-hours for management and the like in the illustrated embodiment.

When the elastic pieces are separately formed from the insulator 12, their shape and size may be suitably designed in consideration of the functions described above, the elasticity, holding force for the nut and the like. Preferred materials for the elastic pieces include brass, beryllium copper, phosphor bronze and the like in consideration of the elasticity.

Moreover, the nut holding structure for the connector 10 according to the invention is not limited to that attached to a substrate as is the case with the illustrated embodiment, and can of course be applied to other structures for mating connectors, panels and the like instead of the substrate by slightly modifying so as to adapt to respective cases.

The contacts 14 will then be explained. The contacts 14 are made of a metal and formed by means of the press-working of the known technique. Preferred metals from which to form the contacts 14 include brass, beryllium copper, phosphor bronze and the like which comply with the requirements such as springiness, electric conductivity and the like.

The contacts 14 each comprise a contact portion 32 adapted to contact a mating object, a fixed portion to be fixed to the insulator 12, and a connection portion 34 to be connected to a substrate or the like. The contact portion 32 is adapted to contact a mating object and may be suitably designed so as to extend into the fitting opening 30 so that the contact portion 32 is brought into contact with the mating object. The fixed portion may be designed so as to be fixed to the insulator 12 by press-fitting, hooking, welding or the like, and is fixed to the insulator by press-fitting in the illustrated embodiment. The connection portion 34 may be suitably designed to be of any type selected from the surface mounting type (SMT) and dip type according to the specification of the substrate and the like, thereby enabling the connection portion to be connected to the substrate. The connection portion is of a surface mounting type in the illustrated embodiment.

In the illustrated embodiment, the nuts 16 are obtained by purchasing commercially available ones. In purchasing the nuts, their size and hence the number of locations for holding and fixing them may be determined in consideration of the holding power of the nuts for the connector, the strength of the insulator 12, ease of insertion of the nuts and the like.

The invention is applicable to connectors 10 for use in a wide variety of electronic and electric appliances and particularly to nut holding structures for mounting the connector 10 onto a substrate.

While the invention has been particularly shown and described with reference to the preferred embodiments thereof, it will be understood by those skilled in the art that the foregoing and other changes in form and details can be made therein without departing from the spirit and scope of the invention.

1. A connector including a plurality of contacts, an insulator for arranging and holding said contacts, and a nut for securing the connector to a substrate or panel,
wherein said insulator is provided at a predetermined position with a flange which is formed with an inserting portion for accommodating said nut, and at said inserting portion at least two elastic pieces are arranged which are elastically deformable and adapted to engage said nut.

2. A nut holding structure for a connector including a plurality of contacts, an insulator for arranging and holding said contacts, and a nut for securing the connector to a substrate or panel,
wherein said insulator is provided at a predetermined position with a flange which is formed with an inserting portion for accommodating said nut, and at said inserting portion at least two elastic pieces are arranged which are elastically deformable and adapted to engage said nut, thereby holding said nut with the engagement with said elastic pieces.

3. The connector as set forth in claim 1, wherein said elastic pieces are substantially in the form of an L-shape and are formed as a cantilever to make them likely to be elastically deformed.

4. The connector as set forth in claim 1, wherein notches or recesses are provided around each of said elastic pieces.

5. The connector as set forth in claim 4, wherein at a tip of said elastic pieces are each provided with guiding portion.

6. The connector as set forth in claim 1, wherein said elastic pieces are formed integrally with or separately from said insulator.

7. The connector as set forth in claim 3, wherein notches or recesses are provided around each of said elastic pieces.

8. The connector as set forth in claim 3, wherein said elastic pieces are formed integrally with or separately from said insulator.

9. The connector as set forth in claim 4, wherein said elastic pieces are formed integrally with or separately from said insulator.

10. The connector as set forth in claim 5, wherein said elastic pieces are formed integrally with or separately from said insulator.
